(19) United States
(12) Patent Application Publication
(10) Pub. No.: US 2016/0189262 A1
(43) Pub. Date: Jun. 30, 2016

(54) SYSTEM AND METHOD FOR BUY THROUGH TRANSACTIONS

(71) Applicant: Oren Raab, Posctcoe (IL)

(72) Inventor: Oren Raab, Posctcoe (IL)

(21) Appl. No.: 14/585,107

(22) Filed: Dec. 29, 2014

(51) Int. Cl. G06Q 30/06; G06Q 30/08

(52) U.S. Cl. CPC G06Q 30/0613; G06Q 30/08

(57) ABSTRACT

In various example embodiments, a system and method for buy through transactions are presented. In an example embodiment, buy through listings for desired products are created by buyers. The buy through listings specify buyer product criteria, which may include product information of the desired products, geographic location information of the desired products, a requested delivery date for the desired products, and pricing information for the desired products. Potential sellers who provide seller purchase criteria may be activated as buy through sellers. The seller purchase criteria may include geographic location information of sellers, product category information related to products the sellers are willing to acquire from third parties, and pricing information related to interested price ranges of the products the sellers are interested in acquiring. The active sellers are provided access to matching buy through listings to bid on.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2014, eBay Inc. All Rights Reserved.

### TECHNICAL FIELD

Embodiments of the present disclosure relate generally to online shopping and, more particularly, but not by way of limitation, to a system and method for buy through transactions.

### BACKGROUND

There are several advantages of online shopping over traditional shopping at physical stores. However, in certain situations, a desired product may not be found by searching listings available on an online shopping site.

### BRIEF DESCRIPTION OF THE DRAWINGS

Various ones of the appended drawings merely illustrate example embodiments of the present disclosure and cannot be considered as limiting its scope.

FIG. 1A is a block diagram illustrating a networked system, according to some example embodiments.

FIG. 1B illustrates a block diagram showing components provided within the publication(s) system shown in FIG. 1A, according to some example embodiments.

FIG. 2A is a block diagram illustrating buyers and sellers interacting with a buy through system, according to some example embodiments.

FIG. 2B is a block diagram illustrating components within a buy through system, according to some example embodiments.

FIG. 3A illustrates an example of buyer product criteria and seller purchase criteria, according to some example embodiments.

FIG. 3B illustrates an example of a buyer record matching various fields in seller records, according to some embodiments;

FIG. 3C illustrates an example of a buy through transaction table, according to some embodiments.

FIG. 4A illustrates an example user interface for searching for a desired product, according to some embodiments.

FIG. 4B illustrates an example user interface for receiving search results regarding a desired product, according to some embodiments.

FIG. 4C illustrates an example user interface for creating a buy through listing for a desired product, according to some embodiments.

FIG. 4D illustrates an example user interface for displaying a buy through listing of a desired product, according to some embodiments.

FIG. 5A illustrates an example user interface for a seller's landing page, according to some embodiments.

FIG. 5B illustrates an example user interface for a seller's opt in to be an active seller, according to some embodiments.

FIG. 6A is a flow diagram illustrating an example method for creating a buy through listing, according to some example embodiments.

FIG. 6B is a flow diagram illustrating an example method for creating a buy through transaction, according to some example embodiments.

FIG. 6C is a flow diagram illustrating an example method for notifying a seller of a dispute related to a buy through transaction, according to some example embodiments.

FIG. 6D is a flow diagram illustrating an example method for activating a buy through seller, according to some example embodiments.

FIG. 6E is a flow diagram illustrating an example method for searching buy through listings, according to some example embodiments.

FIG. 7 is a block diagram illustrating an example of a software architecture that may be installed on a machine, according to some example embodiments.

FIG. 8 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, buyers may create listings on an online shopping site of desired products which are not currently found by searching existing listings on the online shopping site. The listing created by a buyer may be referred to as a buy through listing. A seller who bids on the listing commits to acquire the desired product specified in the buy through listing, generally from a third party. For example the seller, located in another country, may purchase the desired product from third party who is a local merchant in that country. An example of a desired product may be a product not locally available but available for purchase in another country. In one example, a desired product may be a specific coffee brand sold in France which is readily available to locals there, but not available from an online shopping site for purchase in California.

The buy through listing created by the buyer specifies the buyer's product criteria for a desired product that the buyer would like a seller to acquire from a third party. The buyer and the seller may interact directly using a buy through system available from an e-commerce system. The seller and the third party generally interact outside the buy through system in various embodiments.

In various embodiments, when the buyer creates the listing, the buyer may designate a first seller commitment sale or an auction sale. In some embodiments, the buy through listing commits the buyer to purchasing the desired product from a first seller commitment bid. The first seller commitment bid refers to the bid from the first seller who commits to meeting (or matching) the criteria specified in the buyer's product criteria for the buy through listing. In other embodiments, the buy through listing may be used in an auction process. After an auction duration period has ended for a buy through listing, the buyer may select one of the bids submitted by sellers. The buyer's product criteria may include, but not be limited to the product description, the product geographical location, the requested delivery date, and pricing information.

An active seller refers to a seller who has opted into the buy through program on an online shopping site. The active seller may also be referred to as a subscribing seller. In various embodiments, only the active sellers have access to buy through listings. The manner in which the active seller receives notifications or accesses the relevant buy through listings is configured by the active seller. In some embodiments, the active seller may select to receive notifications of buy through listings that match the seller purchase criteria of the active seller. The seller purchase criteria is defined by the seller in various embodiments. The notifications may be sent via email, text, or other communication means. The seller purchase criteria may include the seller's geographic location a radius from the seller's geographic location with which the seller is willing to acquire desired products, and other information. In other embodiments, the active seller may search through a designated buy through page (or user interface) for buy through listings in particular geographic locations. Other search criteria may also be used by the active seller.

Once a bid from an active seller has been accepted by the buyer, either automatically (e.g., first seller commitment sale) or by manual selection by the buyer (e.g., auction sale), a buy through transaction record is created in the buy through system. The buy through transaction record corresponds to a buy through transaction. The buy through transaction is between the buyer who created the buy through listing and seller of the accepted bid of the buy through listing. The buy through listing is tracked in the system during the buy through process. In various embodiments, the buy through process includes creating a buy through listing by a buyer, creating a buy through transaction record associated with a buy through transaction between a buyer and a seller, with the seller acquiring the desired product from a third party, and the buyer receiving the desired product from the seller. The buy through process may also include resolving disputes between the buyer and the seller and writing reviews about the parties in the buy through transaction.

In some cases, a seller in a buy through transaction may not be able to meet the seller's commitment in the buy through transaction. In various embodiments, when the seller is not able to fulfil his or her obligation as specified by the buy through transaction, the seller contacts the buyer and notifies the buyer of the dispute. In example embodiments, the buyer is notified of the dispute through the buy through system. The buyer may be presented with multiple options. For example, the buyer may be presented with an option to (1) accept a delayed delivery date, (2) cancel the buy through transaction, or (3) cancel the buy through transaction and enter into another buy through transaction with a different seller. In some situations, a dispute may arise when the seller is not able to acquire the desired product from the third party because the third party no longer has inventory of the desired product or the desired product is no longer made.

In example embodiments, a buy through system may present various buy through user interface elements (e.g., banners, display buttons, etc.) and views to buyers (or potential buyers) and sellers (or potential sellers) to facilitate participation in the buy through program on an e-commerce site. Collectively, buyers and potential buyers are referred to as “buyers,” and sellers and potential sellers are referred to as “sellers.” In various examples, multiple buy through user interfaces may be presented to users to create buy through listings, search buy through listings, activate buy through sellers, display dispute notifications, and so forth.

In various embodiments, the desired product may be an indigenous item, such as art, instruments, or other collectibles that are native to a particular country or region. In other embodiments, the desired product may be an item that is less expensive in one country or region and more expensive in another country or region. The buyer may be located or have access to the desired product only in the more expensive country or region. In other examples, the desired product may be a product not available for online purchase and only available from a physical store, in a same or different region as a buyer who would like to hire someone else to purchase and deliver the desired product from a physical store on his or her behalf. In some examples, the buy through system encourages various types of sellers to sell items on an e-commerce site. For example, new sellers may be encouraged to test an e-commerce site using the buy through system. In other examples, existing sellers may be encouraged to test new markets or new products on an e-commerce site by using the buy through system. In other examples, a seller who is traveling to another country or region may want to sell local items from that country using the buy through system.

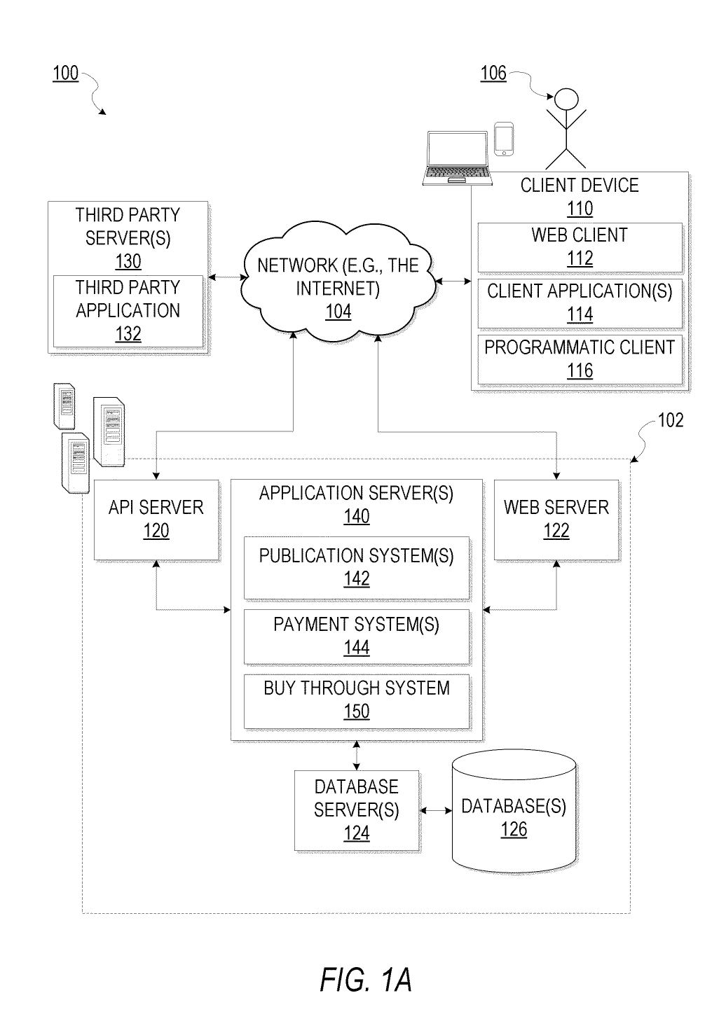

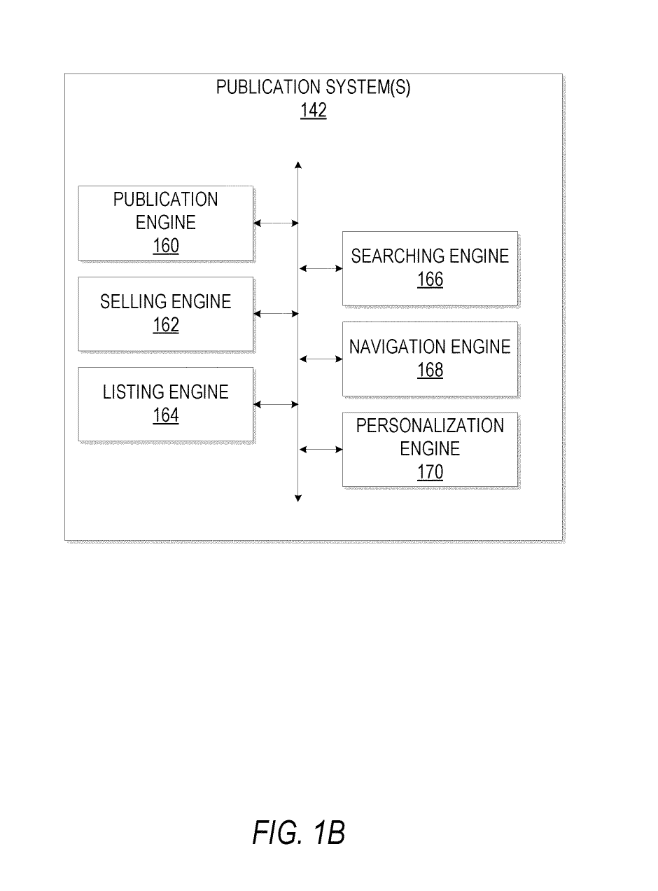

With reference to FIG. 1A, an example embodiment of a high-level client-server-based network architecture 100 is shown. A networked system 102 provides server-side functionality via a network 104 (e.g., the Internet or a Wide Area Network (WAN)) to a client device 110. A user (e.g., user 106) may interact with the networked system 102 using the client device 110. In various embodiments, the user 106 may be a buyer or seller involved in a buy through process. In some embodiments, the buy through process is implemented with the buy through system 150. FIG. 1A illustrates, for example, a web client 112 (e.g., a browser, such as the Internet Explorer® browser developed by Microsoft® Corporation of Redmond, Wash. State), client application(s) 114, and a programmatic client 116 executing on the client device 110. The client device 110 may include the web client 112, the client application(s) 114, and the programmatic client 116 alone, together, or in any suitable combination. Although FIG. 1A shows one client device 110, multiple client devices may be included in the network architecture 100.

The client device 110 may comprise a computing device that includes at least a display and communication capabilities that provide access to the networked system 102 via the network 104. The client device 110 may comprise, but is not limited to, a remote device, work station, computer, general purpose computer, Internet appliance, hand-held device, wireless device, portable device, wearable computer, cellular or mobile phone, personal digital assistant (PDA), smart phone, tablet, Ultrabook, netbook, laptop, desktop, multi-processor system, microprocessor-based or programmable consumer electronic, game consoles, set-top box, network personal computer (PC), mini-computer, and the like. In further example embodiments, the client device 110 may comprise one or more of a touch screen, accelerometer, gyroscope, biometric sensor, camera, microphone, global positioning system (GPS) device, and the like.

The client device 110 may communicate with the network 104 via a wired or wireless connection. For example, one or more portions of the network 104 may be an ad hoc network, an intranet, an extranet, a Virtual Private Network (VPN), a Local Area Network (LAN), a wireless LAN (WLAN), a WAN, a wireless WAN (WWAN), a Metropolitan Area Network (MAN), a portion of the Internet, a portion of the Public Switched Telephone Network (PSTN), a cellular telephone network, a wireless network, a Wireless Fidelity (Wi-Fi®) network, a Worldwide Interoperability for Microwave Access (WiMAX) network, another type of network, or a combination of two or more such networks.

The client device 110 may include one or more of applications 114 (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, e-commerce site apps (also referred to as “marketplace apps” or “publication apps”), and so on. The client application(s) 114 may include various components operable to present information to the user and communicate with networked system 102. In some embodiments, if the e-commerce site application is included in the client device 110, then this application may be configured to locally provide the user interface and at least some of the functionalities with the application configured to communicate with the networked system 102, on an as needed basis, for data or processing capabilities not locally available (e.g., access to a database of items available for sale, to authenticate a user, to verify a method of payment). Conversely, if the e-commerce site application is not included in the client device 110, the client device 110 may use its web browser to access the e-commerce site (or a variant thereof) hosted on the networked system 102.

In various example embodiments, the users (e.g., the user 106) may be a person, a machine, or other means of interacting with the client device 110. In some example embodiments, the users 106 may not be part of the network architecture 100, but may interact with the network architecture 100 via the client device 110 or another means. In some examples, the users 106 may be buyers and sellers of the buy through system 150. For instance, the users 106 may interact with client device 110 that may be operable to receive input information from (e.g., using touch screen input or alphanumeric input) and present information to (e.g., using graphical presentation on a device display) the users. In this instance, the users 106 may, for example, provide input information to the client device 110 that may be communicated to the networked system 102 via the network 104. The networked system 102 may, in response to the received input information, communicate information to the client device 110 via the network 104 to be presented to the users. In this way, the user 106 may interact with the networked system 102 using the client device 110.

An Application Program Interface (API) server 120 and a web server 122 may be coupled to, and provide programmatic and web interfaces respectively to, one or more application server(s) 140. The application server(s) 140 may host one or more publication system(s) 142, payment system(s) 144, and a buy through system 150, each of which may comprise one or more modules or applications and each of which may be embodied as hardware, software, firmware, or any combination thereof. The application server(s) 140 are, in turn, shown to be coupled to one or more database server(s) 124 that facilitate access to one or more information storage repositories or database(s) 126. In an example embodiment, the database(s) 126 are storage devices that store information to be posted (e.g., publications or listings) to the publication system(s) 142. The database(s) 126 may also store digital goods information, in accordance with some example embodiments.

Additionally, a third party application 132, executing on a third party server 130, is shown as having programmatic access to the networked system 102 via the programmatic interface provided by the API server 120. For example, the third party application 132, utilizing information retrieved from the networked system 102, may support one or more features or functions on a website hosted by the third party. The third party website may, for example, provide one or more promotional, marketplace, or payment functions that are supported by the relevant applications of the networked system 102.

The publication system(s) 142 may provide a number of publication functions and services to the users 106 that access the networked system 102. The payment system(s) 144 may likewise provide a number of functions to perform or facilitate payments and transactions. While the publication system(s) 142 and payment system(s) 144 are shown in FIG. 1A to both form part of the networked system 102, it will be appreciated that, in alternative embodiments, each system 142 and 144 may form part of a payment service that is separate and distinct from the networked system 102. In some example embodiments, the payment system(s) 144 may form part of the publication system(s) 142.

The buy through system 150 may provide functionality to allow buyers to create buy through listings and enter into to buy through transactions with sellers who are willing to purchase the desired products from third parties. In some example embodiments, the buy through system 150 may communicate with the client device 110, the third party server(s) 130, the publication system(s) 142 (e.g., retrieving listings), and the payment system(s) 144 (e.g., purchasing a listing). In an alternative example embodiment, the system 150 may be a part of the publication system(s) 142.

Further, while the client-server-based network architecture 100 shown in FIG. 1A employs a client-server architecture, the present inventive subject matter is, of course, not limited to such an architecture and may equally well find application in a distributed, or peer-to-peer, architecture system, for example. The various systems of the applications server(s) 140 (e.g., the publication system(s) 142 and the payment system(s) 144) may also be implemented as standalone software programs, which do not necessarily have networking capabilities.

The web client 112 may access the various systems of the networked system 102 (e.g., the publication system(s) 142) via the web interface supported by the web server 122. Similarly, the programmatic client 116 and client application(s) 114 may access the various services and functions provided by the networked system 102 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner and to perform batch-mode communications between the programmatic client 116 and the networked system 102.

FIG. 1B illustrates a block diagram showing components provided within the publication system(s) 142, according to some embodiments. In various example embodiments, the publication system(s) 142 may comprise a marketplace system to provide marketplace functionality (e.g., facilitating the purchase of items associated with item listings on an e-commerce website). In example embodiments, the buy through system 150 may be integrated, fully or partially, with the publication system(s) 142 or the payment system(s) 144. In other embodiments, the buy through system 150 may be separate from the publication system(s) 142. The publication system(s) 142 may provide some functionality to implement the buy through process to allow buyers to create buy through listings and active sellers to bid on the buy through listings to create buy through transaction records associated with buy through transactions.

The publication system(s) 142 may be hosted on dedicated or shared server machines that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more database(s) 126 via the database server(s) 124.

The publication system(s) 142 may provide a number of publishing, listing, and price-setting mechanisms whereby a seller may list (or publish information concerning) goods or services for sale or barter, a buyer can express interest in or indicate a desire to purchase or barter such goods or services, and a transaction (such as a trade) may be completed pertaining to the goods or services. In further examples, the buyer may create a buy through listing for goods (also referred to as “desired products) or services for sellers to bid on and to create a buy through transaction record associated with a buy through transaction where the seller acquires the desired product from a third party and then delivers the desired product to the buyer using the buy through process.

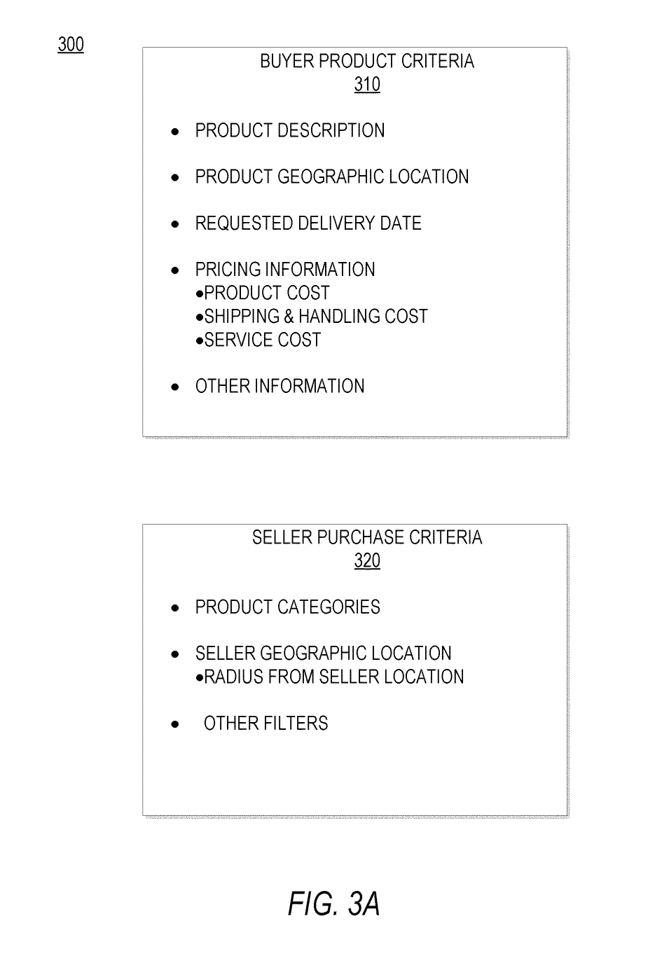

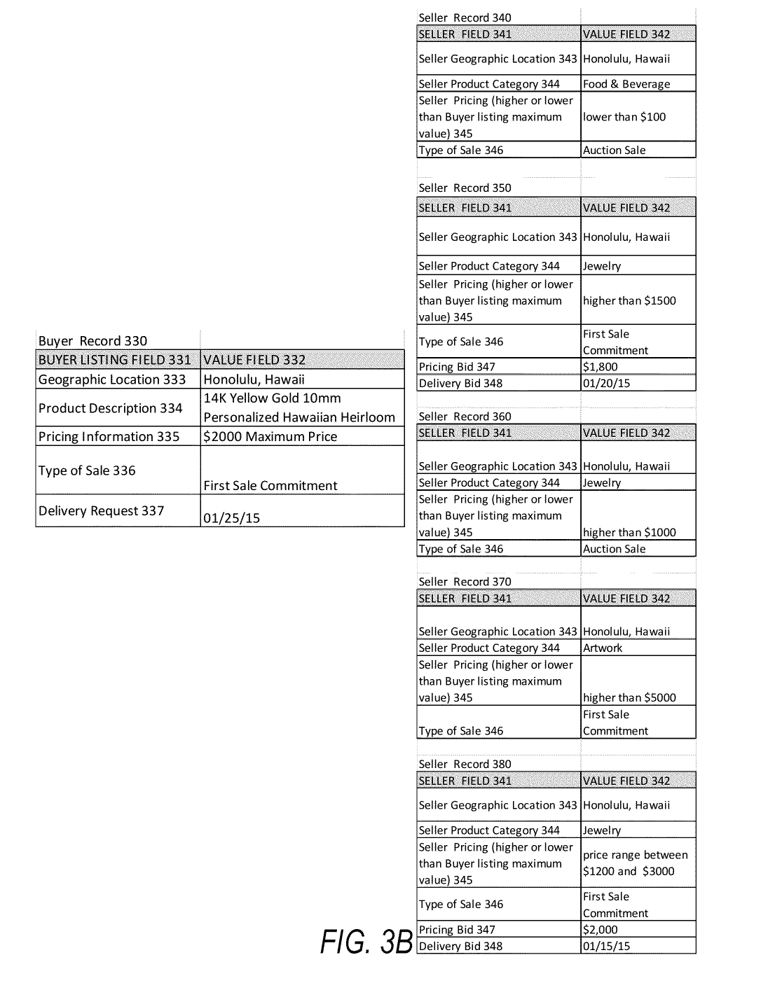

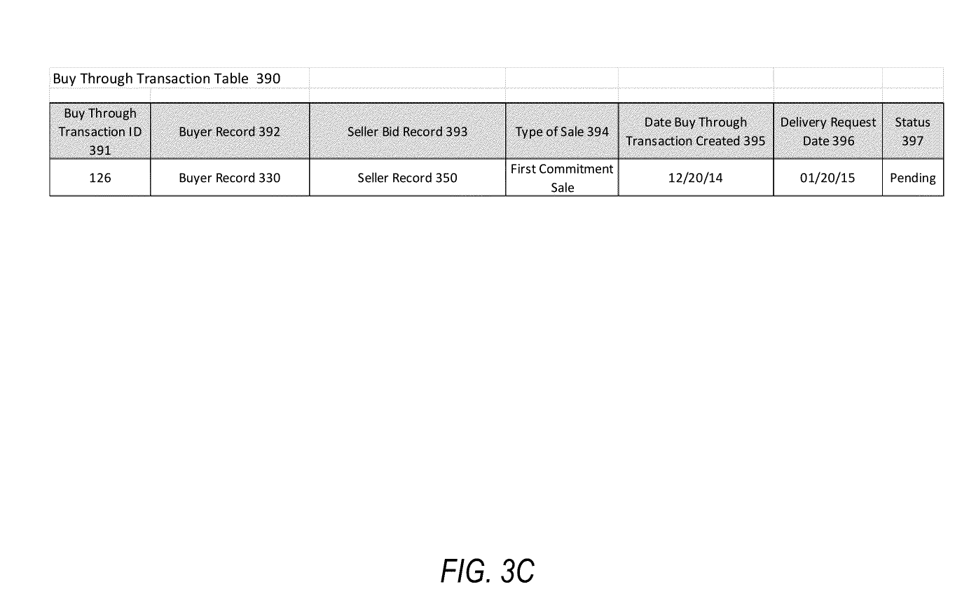

To this end, the publication system(s) 142 may comprise a publication engine 160 and a selling engine 162. The publication engine 160 may publish information, such as item listings or product description pages, on the networked system 102. In various embodiments, the publication engine 160 publishes buy through listings created by buyers that include the buyer product criteria for the desired product. An example of the buyer product criteria is shown in FIG. 3A (buyer product criteria 310).

In some embodiments, the selling engine 162 may comprise one or more fixed-price engines that support fixed-price listing and price setting mechanisms and one or more auction engines that support auction-format listing and price setting mechanisms. The various auction engines may also provide a number of features in support of auction-format listings for buy through listings created by buyers for desired products.

A listing engine 164 allows sellers to conveniently create listings of items. In example embodiments, each good or service (in a listing) is associated with a particular category. The listing engine 164 may receive listing data such as title, description, and aspect name/value pairs. Furthermore, each listing for a good or service may be assigned an item identifier. In other embodiments, a user 106 may create a listing that is an advertisement or other form of information publication. The listing information may then be stored to one or more storage devices coupled to the networked system 102 (e.g., database(s) 126). Listings also may comprise product description pages that display a product and information (e.g., product title, specifications, and reviews) associated with the product. In some embodiments, the product description page may include an aggregation of item listings that correspond to the product described on the product description page.

The listing engine 164 also may allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 164 may receive as much or as little listing data, such as title, description, and aspect name/value pairs, that the buyer is aware of about the requested item. In some embodiments, the listing engine 164 may parse the buyer's submitted item information and may complete incomplete portions of the listing. For example, if the buyer provides a brief description of a requested item, the listing engine 164 may parse the description, extract key terms, and use those terms to make a determination of the identity of the item. Using the determined item identity, the listing engine 164 may retrieve additional item details for inclusion in the buyer item request. In some embodiments, the listing engine 164 may assign an item identifier to each listing for a good or service.

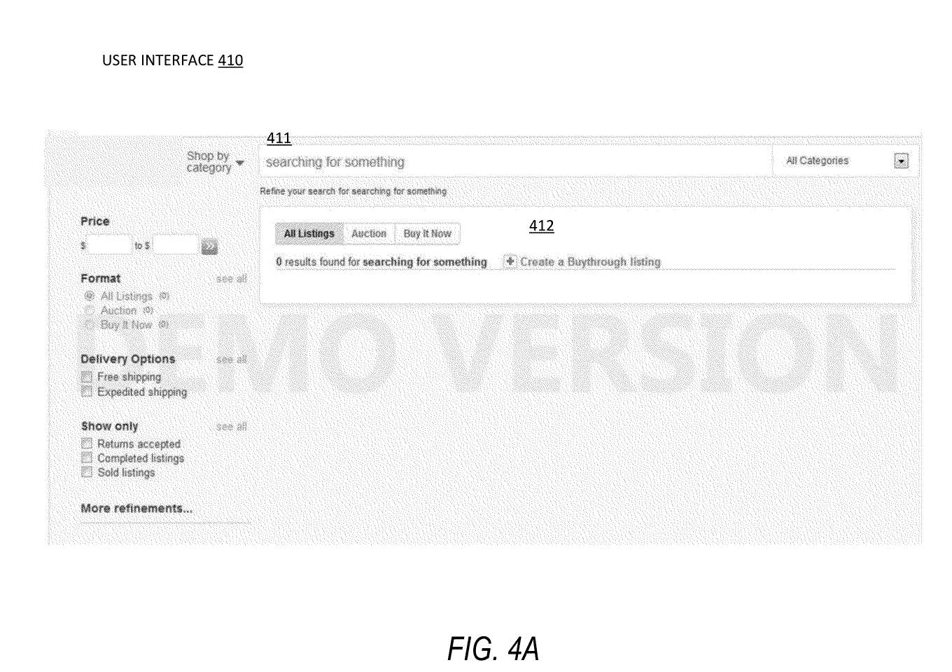

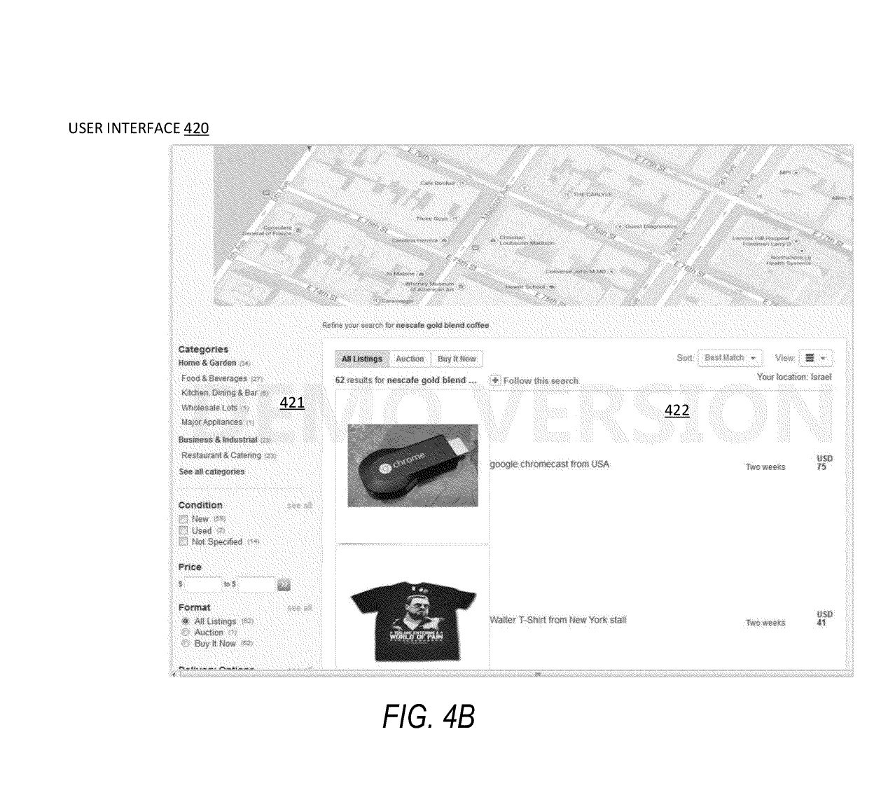

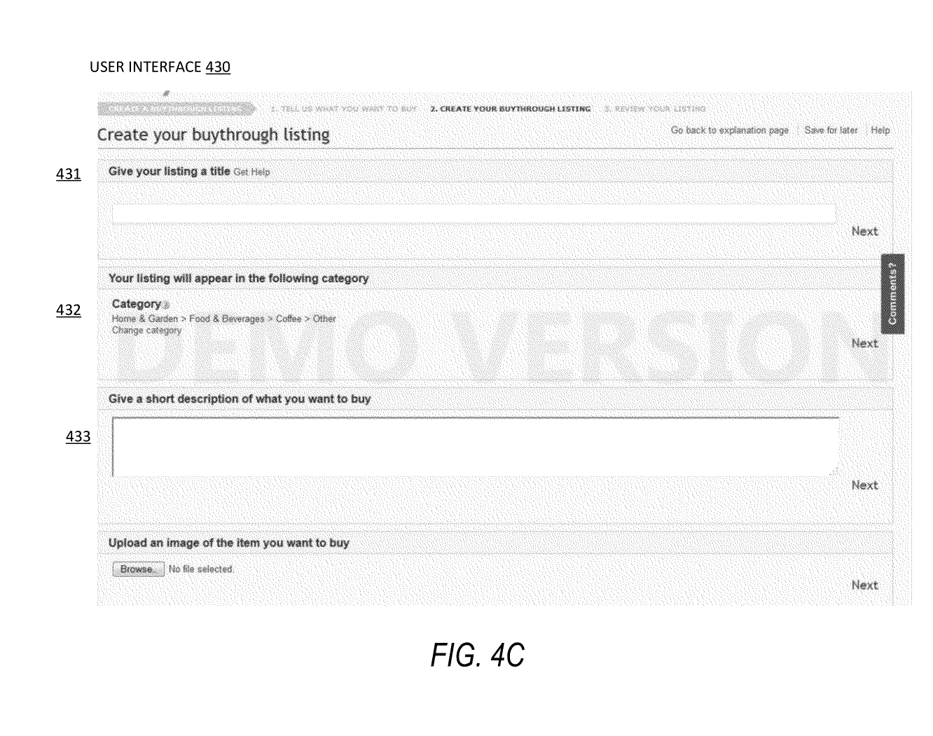

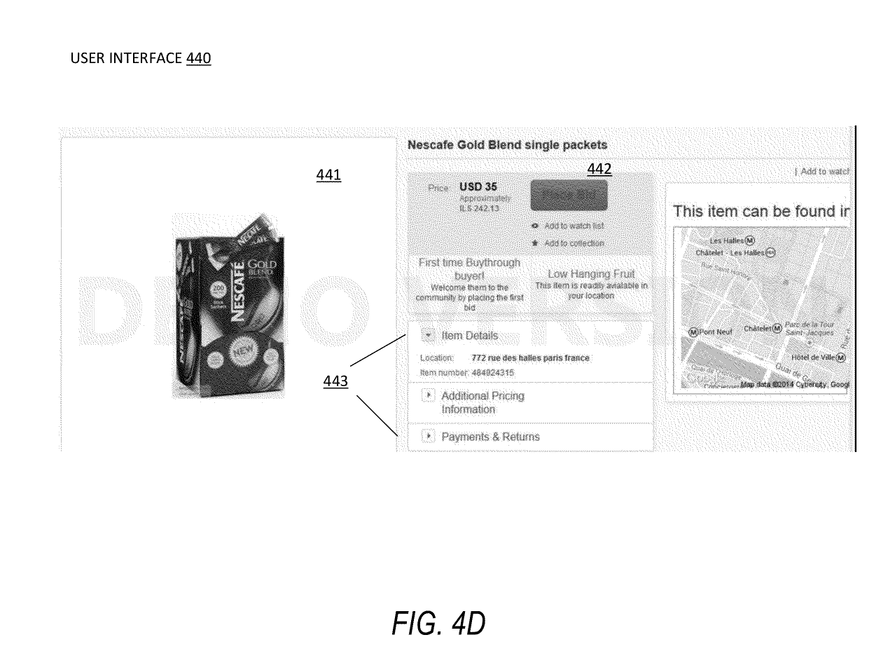

In situations where a desired product may not be available for purchase on the publication system(s) 142, the listing engine 164 may allow a buyer to create a buy through listing for the desired product. Sellers may bid on the buy through listing to create a buy though transaction. An example of a buy through listing is shown in FIG. 4D by a user interface 440. In one embodiment, the listings pertain to goods or services that a user (e.g., a seller or buyer) wishes to transact via the publication system(s) 142. In other embodiments, the listing pertains to goods that a buyer may wish to transact via a buy through transaction to acquire desired products not currently available by seller listings in the publication system(s) 142. In some examples, the buy through listings may be accessible to only sellers who are active sellers. The buy through listings may be accessible via notifications or searching by the seller with relevant filters. In some embodiments, the buy through listings may be accessible through designated buy through user interfaces that allow the active sellers to search buy through listings and receive search results. In various embodiments, the active sellers search buy through listings by geographic locations in which they are willing to acquire the desired products from third parties.

Searching the networked system 102 is facilitated by a searching engine 166. For example, the searching engine 166 enables keyword queries of listings published via the networked system 102. In example embodiments, the searching engine 166 receives the keyword queries from a device 110 of a user 106 and conducts a review of the storage device storing the listing information. The review will enable compilation of a result set of listings that may be sorted and returned to the client device 110 of the user 106. The searching engine 166 may record the query (e.g., keywords) and any subsequent user actions and behaviors (e.g., navigations, selections, or click-throughs). In various embodiments, the buy through listings may be searched by a seller using a designated buy through search page to retrieve buy through listings. The buy through listings may be stored in the same or different storage device storing the other types of listing information.

The searching engine 166 also may perform a search based on a location of the user 106. A user may access the searching engine 166 via a mobile device and generate a search query. Using the search query and the user's location, the searching engine 166 may return relevant search results for products, services, offers, auctions, and so forth to the user 106. The searching engine 166 may identify relevant search results both in a list form and graphically on a map. Selection of a graphical indicator on the map may provide additional details regarding the selected search result. In some embodiments, the user 106 may specify, as part of the search query, a radius or distance from the user's current location to limit search results.

In a further example, a navigation engine 168 allows users to navigate through various categories, catalogs, or inventory data structures according to which listings may be classified within the networked system 102. For example, the navigation engine 168 allows a user 106 to successively navigate down a category tree comprising a hierarchy of categories (e.g., the category tree structure) until a particular set of listings is reached. Various other navigation applications within the navigation engine 168 may be provided to supplement the searching and browsing applications. The navigation engine 168 may record the various user actions (e.g., clicks) performed by the user in order to navigate down the category tree.

In some example embodiments, a personalization engine 170 may allow the users 106 of the networked system 102 to personalize various aspects of their interactions with the networked system 102. For instance, the users 106 may define, provide, or otherwise communicate personalization settings that the personalization engine 170 may use to determine interactions with the networked system 102. In further example embodiments, the personalization engine 170 may automatically determine personalization settings and personalize interactions based on the automatically determined settings. For example, the personalization engine 170 may determine a native language of the user and automatically present information in the native language.

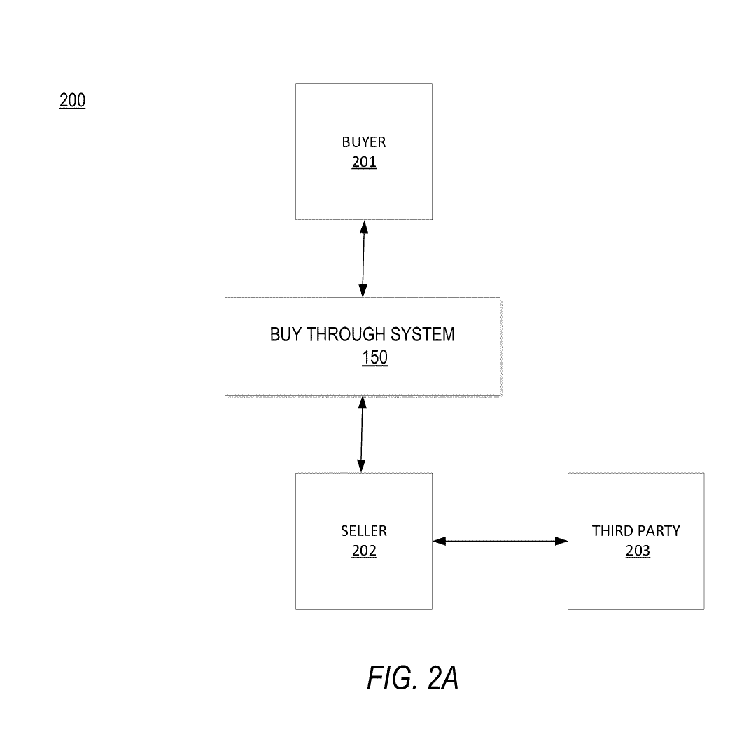

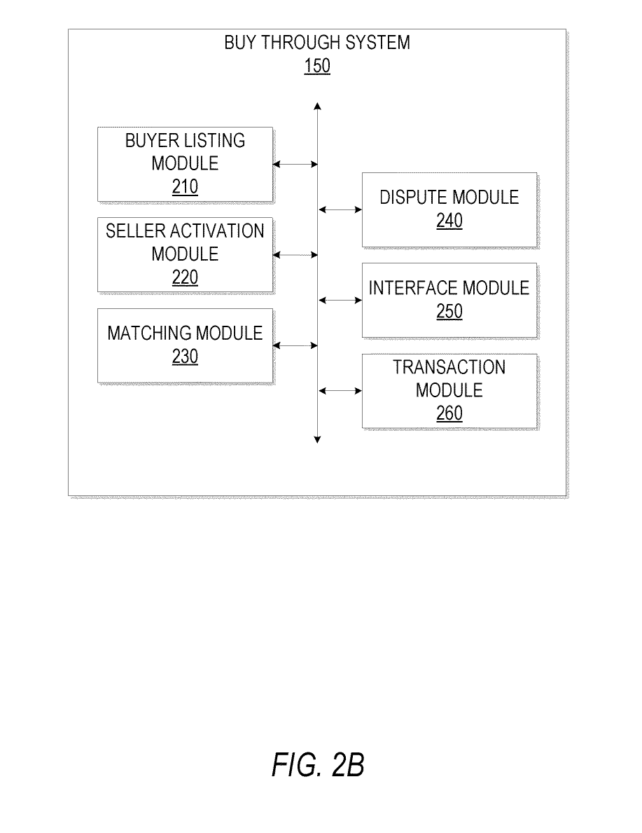

FIG. 2A is a block diagram 200 illustrating buyers and sellers interacting with the buy through system 150, according to some example embodiments. The buy through system 150 may be integrated within the publication system(s) 142 or separate from the publication system(s) 142 that is hosting the e-commerce site used by the buyer and seller. The buy through system 150 provides a mechanism whereby a buyer 201 may interact with a seller 202 to acquire desired products not currently available from the e-commerce site. The buyer 201 may use the e-commerce site to search for a desired product, and if that product is not available from current listings on the e-commerce site, the buyer 201 may create a buy through listing using the buy through system 150. In this example, the seller 202 is an active seller once the seller is a subscriber to the buy through program.

In some embodiments, the buy through listing may commit the buyer 201 to a buy through transaction to the first seller 202 who makes a bid that meets the buyer product criteria specified in the buy through listing. The first seller commitment bid may automatically create a buy through transaction between the buyer 201 and seller 202.

In other embodiments, a bid from seller 202 for a buy through listing may be one of multiple seller bids. The buyer 201 may use an auction process to accept one of the bids from sellers 202. In various embodiments, the buyer 201 considers each of the bids. The buyer 201 may consider one or more of the following factors when accepting a bid from a seller 202: pricing with respect to the desired product cost, shipping and handling, service to acquire the desired product, delivery date provided in the bid, information about a third party 203, and so forth. Once a seller bid is accepted by the buyer 201, a buy through transaction record associated with a buy through transaction is created based on the agreed upon terms between the buyer 201 and the seller 202.

The seller 202 who bids on the buy through listing acquires the desired product from a third party 203. In some embodiments, the third party 203 may be a local merchant, having a physical store or online store, where the desired product may be purchased. In other examples, the desired product is not purchased from a third party 203, but is acquired by some other means. In some situations, the desired product cannot be purchased or acquired by the seller 202 from the third party 203 after the buy through transaction record is created in the buy through system 150. For example, the desired product may no longer be available or no longer made. If the desired product cannot be purchased, the seller 202 contacts the buyer 201 and notifies the buyer 201 using the buy through system 150 in some embodiments. The buyer 201 may be offered one or more options by the buy through system 150 or seller 202.

FIG. 2B is a block diagram illustrating components within a buy through system 150, according to some example embodiments. All, or some, of the modules (also referred to as engines) 160-170 shown in FIG. 1B and the modules 210-260 shown in FIG. 2B, may communicate with each other, for example, via a network coupling, shared memory, and the like. It will be appreciated that each module of modules 160-170 and 210-260 may be implemented as a single module, combined into other modules, or further subdivided into multiple modules. It will further be appreciated that the modules or functionality of the buy through system 150 may be implemented in publication system(s) 142 or the payment system(s) 144. Other modules not pertinent to example embodiments may also be included, but are not shown.

The example of the buy through system 150 shown in FIG. 2B includes a buyer listing module 210, a seller activation module 220, a matching module 230, a dispute module 240, an interface module 250, and a transaction module 260.

The buyer listing module 210 may be integrated with or interact with the listing engine 164 (shown in FIG. 1B) in some embodiments. The buyer listing module 210 provides functionality to allow buyers 201 to create buy through listings using one or more buy through user interfaces. In one example, the buyer 201 searches for a desired product on an e-commerce site. For example the buyer 201 may use the user interface 410 shown in FIG. 4A to search for a desired product from all listings available on the e-commerce site. The buyer 201 may enter the buyer's search criteria into the field 411. FIG. 4B illustrates an example of search results that are displayed for the search criteria “nescafe gold blend coffee.” Unfortunately, the search results 421 shown in FIG. 4B do not display any items referred to as “nescafe gold blend coffee.” Also note that the search results are provided for a buyer 201 with a location in Israel shown by field 422. In this example, the buyer 201 may know that that this brand of coffee is readily available for purchase in France. After searching all the listings on the e-commerce site through the user interface 420, the buyer 201 may be interested in creating a buy through listing by selecting the user interface element 412 (e.g., link for Create a Buythrough listing) shown in FIG. 4A.

FIG. 4C illustrates a user interface 430 used in an example embodiment to create a buy through listing. The user interface 430 provides a field 431 for the buyer 201 to provide a title for the buy through listing. The user interface 430 provides a field 432 for the buyer 201 to provide a category for the desired product. The user interface 430 provides a field 433 for the buyer 201 to provide a short description of the desired product. The buyer listing module 210 provides additional buy through interfaces (not shown) that the buyer 201 can use to add information to create the buyer's buy through listing. In various embodiments, the buy through listing includes the buyer product criteria 310 shown in FIG. 3A. The buyer product criteria 310 is shown for illustrative purposes, and the buyer product criteria in other embodiments may include additional or different criteria as shown in the buyer product criteria 310.

FIG. 4D illustrates a user interface 440 displaying a buy through listing created by the buyer 201 using the buyer listing module 210. The desired product 441 represents Nescafe Gold Blend single packets. Some of the buyer product criteria are shown by user interface elements 443 (e.g., item details, additional pricing information, and payments and returns). The user interface elements 443 may be expanded to view additional information provided by the buyer 201. A user interface element 442 is a button that allows sellers 202 to bid on the buy through listing shown by user interface 440.

The seller activation module 220 provides functionality for sellers 202 to subscribe to or opt into the buy through program associated with an e-commerce site (or publication system(s) 142). The seller activation module 220 provides various user interfaces to provide information to a seller 202 to learn more about the buy through program and to opt into the buy through program to become an active seller 202. In various embodiments, the seller activation module 220 may be integrated with or interface with the selling engine 162, the publication engine 166, and the personalization engine 170, as well as various components within the buy through system 150.

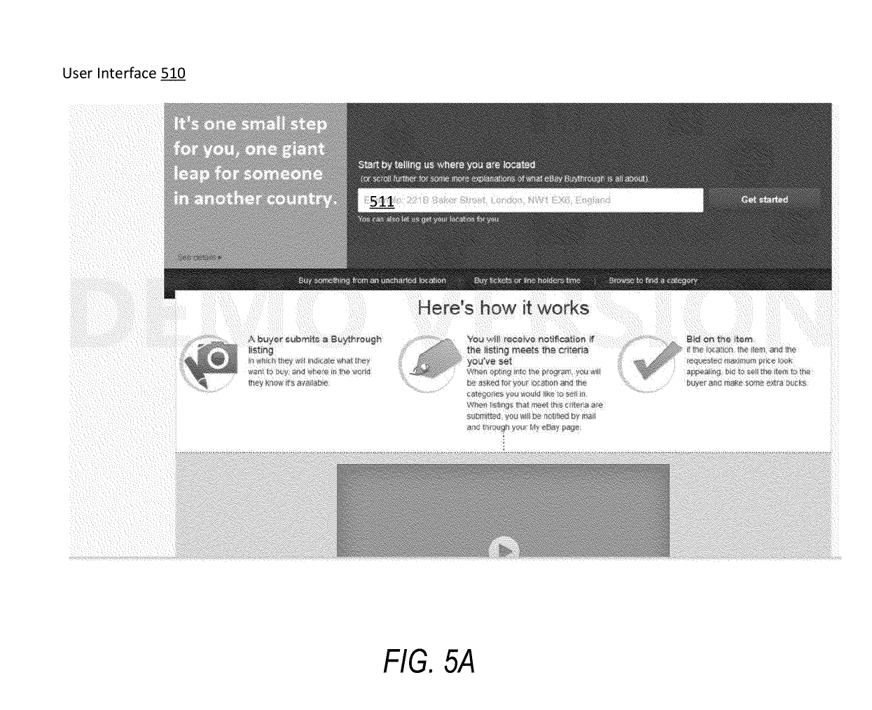

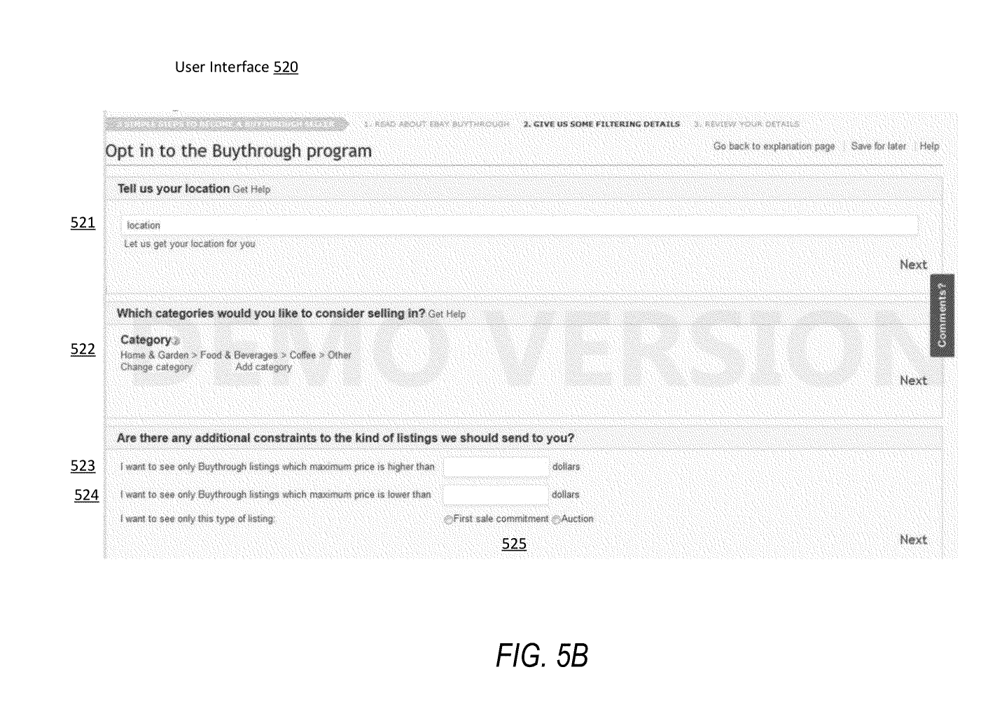

FIG. 5A illustrates a user interface 510, according to an example embodiment, that shows a landing page for a seller 202. The landing page includes a field 511 requesting that the seller 202 provide location information. The description of the buy through program in the landing page outlines three simple steps related to the seller 202: (1) the buyer 201 submits a buy through listing; (2) the seller 202 receives notification if the listing meets the criteria set by the seller 202 (also referred to as the seller purchase criteria); and (3) the seller 202 bids on the item (also referred to as the desired product). An example of a seller purchase criteria 320 is shown in FIG. 3A. The example of seller purchase criteria 320 shown in FIG. 3A includes product categories, seller geographic location (including a radius from the seller's geographic location within which the seller 202 is willing to acquire desired products), and other filters set by the seller 202. The seller purchase criteria 320 may be used by the buy through system 150 to locate relevant buy through listings for a seller 202.

FIG. 5B illustrates another user interface 520 provided by the seller activation module 220. The user interface 520 illustrates an opt in page for a seller 202 to opt into the buy through program. The opt in page includes a field 521 for the seller to provide the seller's location, a category field 522 for the seller 202 to select categories to which the seller would like to have access (either by notification or search), a field 523 for the seller 202 to specify access to listings in which the maximum amount is higher than a seller specified amount, a field 524 for the seller 202 to specify access to listings in which the maximum amount is lower than a seller specified amount, and a field 525 for the seller to select a first seller commitment sale or auction sale.

The matching module 230 provides functionality to match buyer listings with active sellers who have seller purchase criteria that match the buyer product criteria. Referring back to FIG. 3A, an example of buyer product criteria 310 and an example of seller purchase criteria 320 are shown. In various embodiments, a match between the buyer product criteria 310 and seller purchase criteria 320 refers to one or more matching criteria from the buyer product criteria 310 and the seller purchase criteria 320. For example, in various embodiments, the matching module 230 identifies a match when the product description in the buyer product criteria falls within the product category specified in the seller purchase criteria, and the product geographic location in the buyer product criteria falls within the radius from the seller location within which a seller 202 is willing to acquire desired products. In other embodiments, additional or different criteria may be used to identify a match. Once the matching module 230 identifies a match, the sellers 202 with matches are provided with access to the buy through listing. In one example, the seller 202 may receive notifications of the relevant buy through listings. In another example, the seller 202 may have access to buy through listings as part of the search results when the search criteria matches the buyer product criteria 310. In various embodiments, the search criteria may also represent seller purchase criteria 320.

During the opt in process to activate sellers for the buy through program, the seller 202 selects how they would like to receive buyer listing information. For example the seller 202 may select to receive notification by email, either for individual buyer listings or as part of a daily, weekly, or monthly digest. In the example shown in FIG. 5B, the seller 202 may also select to access the buyer listings after searching and filtering on the relevant parameters through a designated search page on the e-commerce site.

FIG. 3B illustrates an example of matching a buyer listing with the purchase criteria 320 of active sellers 202. In example embodiments, the buyer record 330 represents a buyer listing accessible or stored in one or more tables in the buy through system 150. The buyer listing may include one or more criteria from the buyer product criteria 310. The seller records 340-380 represent examples of seller purchase criteria 320 for active sellers 202 also accessible or stored in one or more tables in the buy through system 150. The seller records 340-380 may also include biding information such as pricing bid 347 and delivery bid 348 fields. In FIG. 3B, the seller records 350 and 380 include bidding information for the pricing bid 347 and the delivery bid 348. In other embodiments, other bidding information may be included. The buyer record 330 and the seller records 340-380 may be stored tables in one or more databases 126 and accessed by the buy through system 150 through database server(s) 124. In this example, the buyer record 330 includes header fields for a buyer listing field 331 and a value field 332, and the seller records 340-380 includes header fields for seller fields 341 and corresponding value fields 342.

According to FIG. 3B, the buyer record 330 includes a geographic location 333 of Honolulu, Hi.; a product description 334 of a 14 karat (14K) gold 10 millimeter (mm) personalized Hawaiian heirloom bracelet, size 8; pricing information 335 specifying a maximum price of $2000 that the buyer 201 is willing to pay a seller 202 for a buy through transaction, a type of sale 336 representing a first sale commitment, and a delivery request 337 of Jan. 25, 2015. In this example, each of the seller records 340-380 includes value fields 342 corresponding to the following seller fields 341: a seller geographic location 343, a seller product category 344, a seller pricing 345, and a type of sale 346. Additionally, some of the seller records (e.g., seller records 350 and 380) include other seller fields 341 and corresponding value fields 342. All five seller records 340-380 have seller geographic locations 343 that match the buyer listing geographic location 333 of Honolulu, Hi. Only three of the records (seller records 350, 360, and 380) have seller product categories 344 that match the buyer listing product description 334. The product description 334 of the buyer record 330 describes a bracelet which is a type of jewelry. The seller records 350, 360, and 380 show a seller product category 344 of jewelry.

The seller records 350, 360, and 380 are also the only three records in this example having the seller pricing 345 match the buyer listing pricing information 335. The buyer listing pricing information 335 of $2000 maximum price is higher than the seller pricing 345 of $1500 shown in the seller record 350 and the seller pricing 345 of $1000 shown in the seller record 360. Additionally, the buyer listing pricing information 335 of $2000 is between the pricing range (i.e., $1,200 and $5,000) specified in the seller pricing 345 shown in the seller record 380 In this example, the seller records 350 and 380, which specifies a value field 342 of a first sale commitment for the type of sale 346 matches the buyer listing type of sale 336.

In this example, the system 150 determines a match between the buyer listing fields 333-336 from the buyer record 330 and the fields 343-346 from the seller records 350 and 380. In some embodiments, once a match between the buyer product criteria 310 (which may be represented by fields 333-336) and the seller purchase criteria 320 (which may be represented by fields 343-346) is found, the sellers associated with these matching records (e.g., 350 and 380), may place a bid for this buy through listing (associated with the buyer record 330) in the buy through system 150. In other words, the sellers 202 may have access to the buy through listing to place a bid. The seller record 350 includes a pricing bid 347 of $1,800 and a delivery bid 348 of Jan. 20, 2015. The seller record 380 includes a pricing bid 347 of $2,000 and a delivery bid 348 of Jan. 15, 2015. Both seller records 350 and 380 includes seller bidding information that meets the buyer product criteria specified in the buyer record 330 for price (i.e., the pricing information 335) and delivery (i.e., the delivery request 337). Additionally, since the buy through transaction is specified as a first sale commitment in the buyer record 330, the first seller to commit to meeting the buyer product criteria 310 specified in the buyer record may automatically create the buy through transaction record (associated with the buy through transaction) in the buy through system 150. As discussed above, the seller associated with the seller record 350 and the seller associated with the seller record 380 both have committed to meeting the buyer product criteria 310 shown in the buyer record 330.

In this example, assume that the first seller to place a bid in the buy through system 150 for the buy through listing associated with the buyer record 330 is the seller associated with the seller record 350, and the second seller to place a bid in the buy through system 150 for the buy through listing associated with the buyer record 330 is the seller associated with the seller record 380. In some embodiments, since the buyer record 330 specifies a first commitment sale as the type of sale 336, the first seller to place the bid is automatically selected by the buy through system 150 as the seller 202 for the buy through transaction. In various embodiments, the buy through system 150 automatically creates a buy through transaction record once the first sale commitment bid is received. In this example, the seller associated with the seller record 350 represents the first seller to place a bid that commits to meeting the buyer product criteria 310 shown in the buyer record 330 and is the selected seller. The buy through transaction for the listing represented by the buyer record 330 is between the buyer 201 associated with the buyer record 330 and the seller 202 associated with the seller record 350.

FIG. 3C illustrates an example of a portion of buy through transaction table 380. The buy through transaction table 380 includes a single buy through transaction record for the buy through transaction between the buyer 201 associated with the buyer record 330 and the seller 202 associated with the seller record 350. The buy through transaction is assigned a buy through transaction identification number (ID) of 126 shown in a buy through transaction ID 391 field. The fields shown in the buy through transaction table 390 illustrate an example of fields that may be included in transaction table 380. The example buy through transaction table 390 includes the following fields: the buy through transaction ID 391, a buyer record 392, a seller bid record 393, a type of sale 394, date buy through transaction created 395, delivery request date 396, and status 397. In alternative embodiment, the buy through transaction table 380 may include any number of buy through transaction records and various other fields to log and track buy through transactions. In example embodiments, the buy through transaction table 380 may be stored in tables in one or more databases 126 and accessed by the buy through system 150 through database server(s) 124. In various embodiments, a buy through transaction may be represented by one or more records stored in the buy through transaction table 380. The buy through transaction may represent an agreement between a buyer 201 and a seller 202 based upon the pricing, delivery and other terms agreed upon by the parties (i.e., the buyer 201 and the seller 202) to the buy through transaction.

The dispute module 240 provides functionality to enable communications between a buyer 201 and a seller 202 when a dispute arises related to a buy through transaction. In some embodiments, the dispute module 240 may provide functionality to enable the resolution of a dispute between a buyer 201 and a seller 202. In some situations, a dispute may arise when the seller 202 is not able to acquire the desired product from the third party because the third party no longer has inventory of the desired product or the desired product is no longer being made.

A seller 202 in a buy through transaction may not be able to meet the seller's 202 commitment for a buy through transaction for a variety of reasons. For example, various factors such as a delayed delivery date, increase in cost of the desired product from the third party due to product demand, unavailability of the desired product, and the like, may make it difficult or impossible for the seller 202 to fulfill the seller's 202 commitment in the buy through transaction.

In some examples, the agreed upon terms in the buy through transaction are based on the buyer product criteria or modifications to the buyer product criteria. In various embodiments, when the seller 202 is not able to fulfil his or her obligation as specified by the terms in the buy through transaction, the seller 202 sends a dispute notification to the buy through system 150 to inform the buyer 201 of the dispute. The buyer 201 may be presented with multiple options. For example, the buyer 201 may be presented with an option to (1) accept a delayed delivery date, (2) cancel the buy through transaction, or (3) cancel the buy through transaction and enter into another buy through transaction with a different seller. In other embodiments, other options may be available or offered to the buyer 201. The buyer then selects one of the presented options, and the buy through transaction is updated accordingly. For example, the buy through transaction may be modified, canceled, or replaced with a new buy through transaction.

The interface module 250 provides functionality, in conjunction with at least the buyer listing module 210, seller activation module 220, the matching module 230, and the dispute module 240, to provide various user interfaces to the buyer 201 and the seller 202. Examples of some user interfaces are shown in FIGS. 4A-4D and FIGS. 5A-5B.

The transaction module 260 provides functionality to create, track, modify, and cancel buy through transactions. In various embodiments, a buyer 201 may designate whether a buy though listing is a first seller commitment bid or an auction bid. In further embodiments, the seller 202 may designate whether the seller 202 is interested in receiving only first seller commitment bids, only auction bids, or both first seller commitment bids and auction bids. In example embodiments, a buy through transaction is automatically created for a buy through transaction when a first seller commitment bid is received. The buy through listing created by the buyer 201 provides a commitment for the buyer 201 to a buy through transaction when a first seller commitment bid is received. In other embodiments, a buy through transaction is created via an auction process. During the auction process for a buy through listing, multiple bids from sellers 202 may be received during an auction period. Once the auction period ends, the buyer 201 accepts one of the seller bids. The buyer 201 may decide on which seller bid to accept based on information provided by the seller 202 in the seller's 202 bid. In one example, the seller 202 may specify information about the third party that may influence the buyer's 201 decision to select the seller 202, even if the seller's 202 bid does not offer the lowest price for the desired product. In another example, buyer 201 may select the seller's 202 bid that offers the best shipping and handling costs. In a different example, the buyer 201 may select the seller's 202 bid that provides information about import fees and taxes.

In an example embodiment, the buy through system 150 includes a buyer listing module 210 configured to receive buyer information specifying buyer product criteria used to create the buy through listings for desired products. The buyer product criteria may include product information of the desired products, geographic location information of the desired products, a requested delivery date for the desired products, and pricing information for the desired products. The buy through system 150 also includes a seller activation module 220 configured to receive seller information specifying seller purchase criteria related to potential buy through transactions. The seller purchase criteria may include geographic location information of sellers 202, product category information related to products the sellers 202 are willing to acquire from third parties for the potential buy through transactions, and pricing information related to price ranges of products the sellers 202 are interested in acquiring for the potential buy through transactions. Additionally, the buy through system 150 includes a matching module 230 configured to provide access to the buy through listings to sellers 202 who have seller purchase criteria matching the buyer product criteria of the buy through listings.

In various embodiments, the buyer product criteria 310 includes the product information representing a desired product not currently available for online purchase by the buyer 201 based on current product listings on an e-commerce site, geographic location information representing a non-local region where the desired product is sold, and pricing information representing a desired buying price.

In other embodiments, the buy through system 150 also includes a transaction module 260 configured to receive at least one bid for one of the buy through listings. In further embodiments, after an expiration of a listing auction duration, the transaction module 260 is configured to receive, from the buyer 201 of the one of the buy through listings, an acceptance of one of the at least one bid from a seller 202. The transaction module 260 is further configured to create a buy through transaction between the buyer 201 and the seller 202 once the seller's 202 bid has been accepted.

In example embodiments, the transaction module 260 is configured to receive a first seller commitment bid for one of the buy through listings. The receipt of the first seller commitment bid automatically creates a buy through transaction between the buyer 201 and the seller 202.

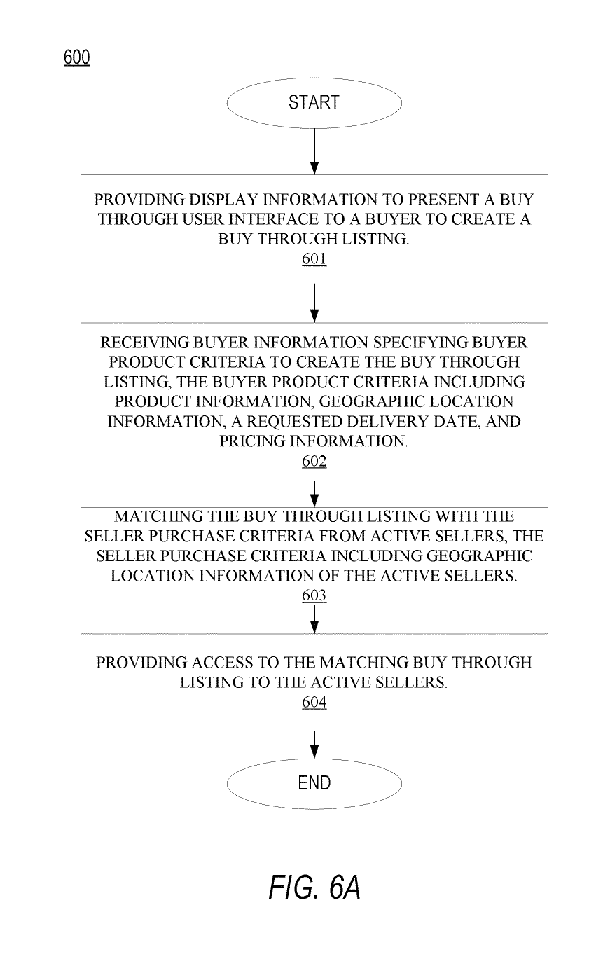

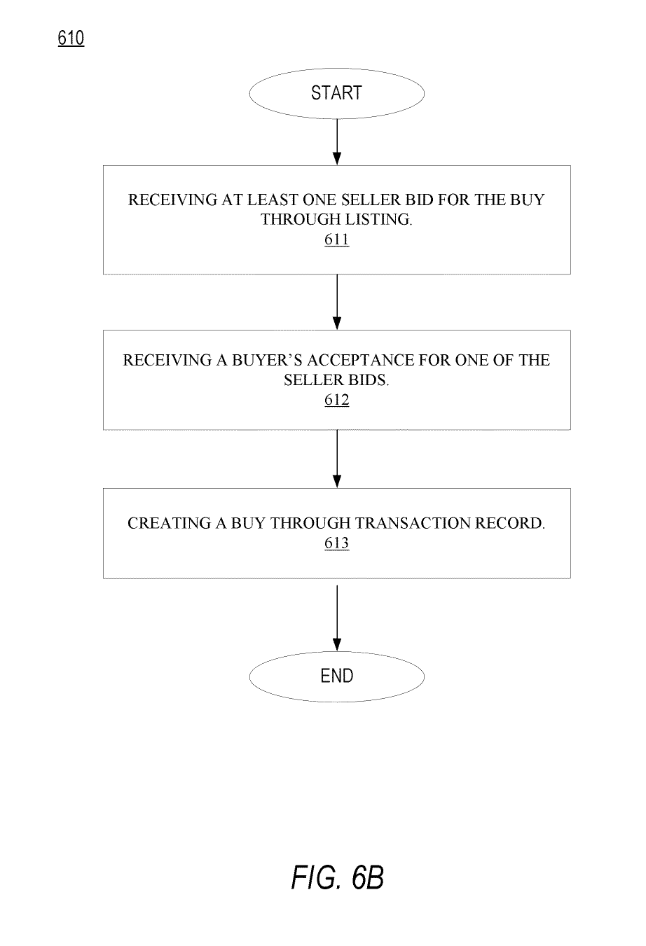

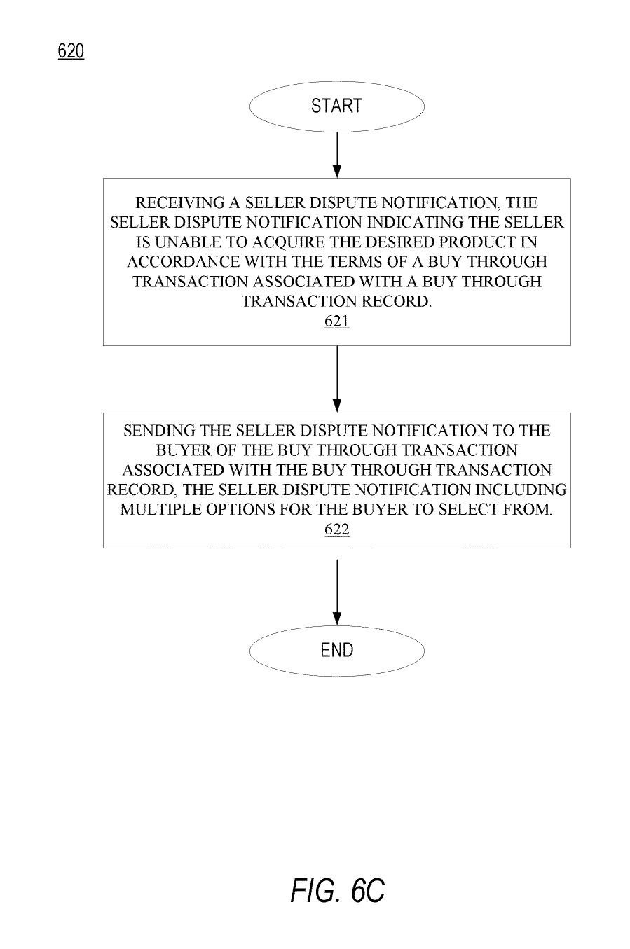

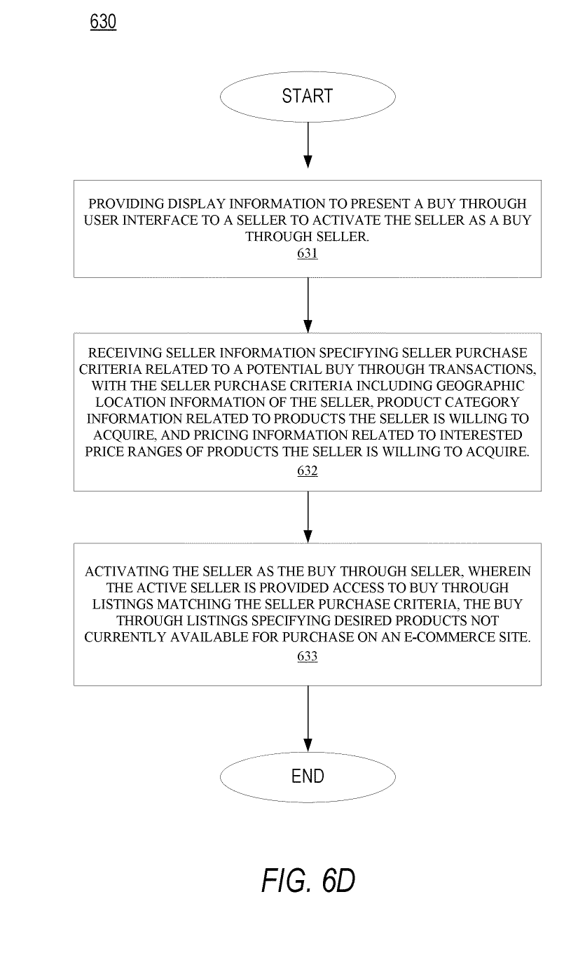

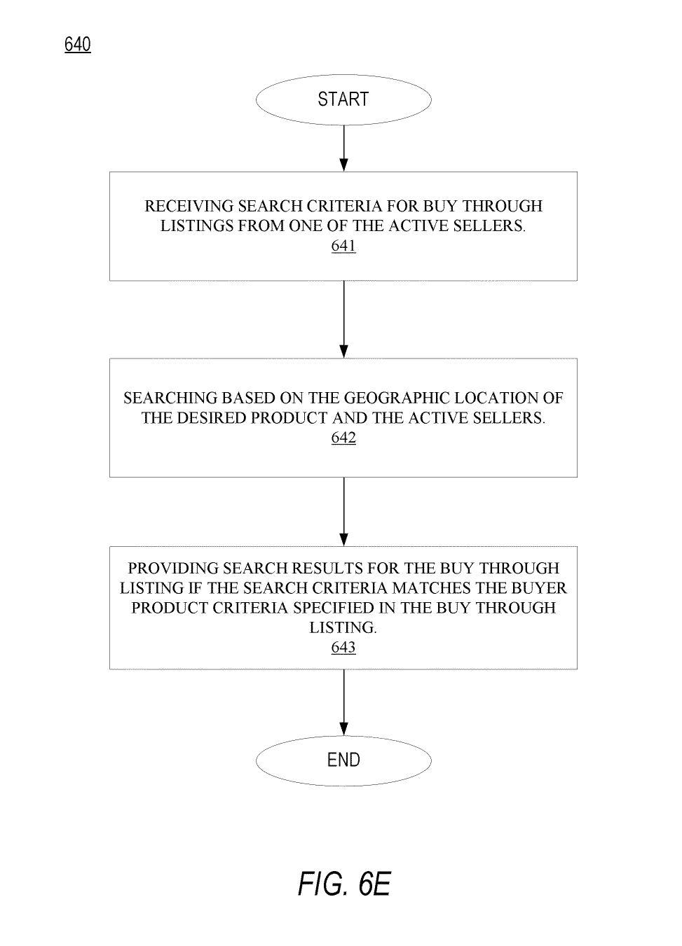

FIGS. 6A-6E illustrate flow diagrams for various embodiments. In various embodiments, additional operations may be added to each of the flow diagrams 600-640, or one or more operations may be deleted from each of the flow diagrams 600-640. In further embodiments, the operation of flow diagrams 600-640, or variants of these flow diagrams, may be combined. The operations performed in the flow diagrams 600-640 may be performed by one or more components or modules within the buy through system 150, the publication system(s) 142, or the payment system(s) 144.

FIG. 6A is a flow diagram illustrating an example method for creating a buy through listing, according to some example embodiments. The flow diagram 600 includes operations 601-604. In an example embodiment, a flow diagram 600 includes: at operation 601, providing display information to present a buy through user interface to a buyer 201 to create a buy through listing; at operation 602, receiving buyer information specifying buyer product criteria to create the buy through listing, with the buyer product criteria including product information, geographic location information, a requested delivery date, and pricing information; at operation 603, matching the buy through listing with seller purchase criteria from active sellers 202, with the seller purchase criteria including geographic location information of the active sellers; and at operation 604, providing access to the matching buy through listing to the active sellers 202. In further embodiments, the product information represents a selected product not currently available for online purchase by the buyer 201 based on current product listings on an e-commerce site. In other embodiments, the geographic location information represents a non-local region where the selected product is sold. In another embodiment, the pricing information represents a desired buying price. In a further embodiment, the pricing information represents a desired buying price, which includes a breakdown of pricing by at least product cost, service cost, and shipping cost.

FIG. 6B is a flow diagram illustrating an example method for creating a buy through transaction, according to some example embodiments. The flow diagram 610 includes operations 611-613. In an example embodiment, flow diagram 610 includes: at operation 611, receiving at least one seller bid for the buy through listing, the at least one seller bid including a response to the buyer product criteria; at operation 612, receiving a buyer's acceptance for one of the seller bids; and, at operation 613, creating a buy through transaction record.

In one embodiment, providing access to the buy through listing to the active sellers 202 includes providing notification to the active sellers 202 matching the buy through listing.

In an example embodiment, receiving at least one seller bid for the buy through listing includes receiving a first bid from a seller 202 of the sellers 202 who were provided access to the buy through listings, with the first seller commitment bid including a commitment from the first seller 202 to meet the buyer product criteria; and creating the buy through transaction record associated with a buy through transaction includes automatically creating the buy through transaction record associated with the buy through transaction.

In another example embodiment, receiving at least one seller bid for the buy through listing includes receiving multiple seller 202 bids. In further embodiments, receiving a buyer's 201 acceptance for one of the seller 202 bids after an expiration of an auction duration period for the buy through listing includes receiving the buyer's 201 acceptance of one of the multiple seller 202 bids.

FIG. 6C is a flow diagram illustrating an example method for notifying a seller of a dispute related to a buy through transaction associated with a buy through transaction record, according to some example embodiments. The flow diagram 620 includes operations 621-622. In an example embodiment, flow diagram 620 includes: at operation 621, receiving a seller dispute notification, with the seller dispute notification indicating the seller is unable to acquire the selected product in accordance with terms in a buy through transaction associated with the buy through transaction record; and, at operation 622, sending the seller dispute notification to the buyer 201 of the buy through transaction associated with the buy through transaction record, with the seller dispute notification including multiple options for the buyer 201 to select from. The multiple options may include at least one of the following options for the buyer 201 to select from: the buyer 201 can accept a delayed delivery date, the buyer 201 can cancel the buy through transaction, or the buyer 201 can cancel the buy through transaction and enter into a second buy through transaction with a second seller.

FIG. 6D is a flow diagram illustrating an example method for activating a buy through seller 202, according to some example embodiments. The flow diagram 630 includes operations 631-633. In an example embodiment, flow diagram 630 includes: at operation 631, providing display information to present a buy through user interface to a seller 202 to activate the seller 202 as a buy through seller 202; at operation 632, receiving seller information specifying seller purchase criteria related to a potential buy through transaction, with the seller purchase criteria including geographic location information of the seller, product category information related to products the seller is willing to acquire, and pricing information related to interested price ranges of products the seller is willing to acquire; and at operation 633, activating the seller 202 as the buy through seller 202, wherein the active seller 202 is provided access to buy through listings matching the seller purchase criteria, with the buy through listings specifying selected products not currently available for purchase on an e-commerce site.

FIG. 6E is a flow diagram illustrating an example method for searching buy through listings, according to some example embodiments. The flow diagram 640 includes operations 641-643. In an example embodiment, flow diagram 640 includes: at operation 641, receiving search criteria for buy through listings from one of the active sellers 202; at operation 642, searching based on the geographic location of the selected product and the active sellers 202; and at operation 643, providing search results for the buy through listing if the search criteria matches the buyer product criteria specified in the buy through listing. In one embodiment, the seller purchase criteria includes seller location information representing an address where the seller 202 is located and a radius from the address that the seller 202 is willing to acquire products from a third party for the buy through listing. For an example embodiment, receiving the seller purchase criteria includes the seller location information representing an address where the seller 202 is located and a radius from that address within which the seller is willing to acquire selected products from the third party for the buy through listings.

In an example embodiment, the buy through process for a buyer 201 may start with the buyer 201 searching for a desired product on an e-commerce site and getting zero search results. In addition to an indication of zero search results, the buyer 201 may get a link offering the buyer 201 a way to submit a buy through listing. The buyer 201 may start the buy through listing creation flow by browsing through the e-commerce site tree or other applicable links. The buyer 201 fills in the relevant information on a buy through user interface used for creating new buy through listings. The relevant information may include title, location of the item, item image, category of the item, maximum price they are willing to pay for the desired product, shipping and handling, and any additional information the buyer 201 may want to contribute. The buyer 201 submits the buy through listing, which becomes a live buy through listing on the e-commerce site. In further embodiments, a seller 202 (also referred to as an active seller) may receive notification by email for individual listings or combined listings as part of a daily, weekly, or monthly digest of buy through listings. In an alternative embodiment, the seller 202 finds the listing after searching and filtering on the relevant parameters through a designated buy through search page on the e-commerce site.

The seller 202 may submit a bid on the buy through listing, at or lower than the buyer's maximum price. The pricing offered by the seller 202 represents a response to the buyer product criteria in the buy through bid. In some embodiments, the buy through listing is submitted as a first seller commitment listing. For buy through listings submitted as a first seller commitment, the seller's bid is automatically accepted and the buy through transaction is set when the first seller commitment bid is received by the buy through system 150. A buy through transaction record is created for the buy through transaction. The seller 202 is required to supply the desired product to the buyer 201 within the relevant shipping and handling time as indicated by the seller 202 in the bid. In other embodiments, the buy through listing is submitted as an auction listing with an auction duration period. For auction listings, the buyer 201 reviews all bids from multiple sellers 202 and accepts one of the bids. A buy through transaction represents an agreement between the buyer 201 who created the listing and the seller 202 whose bid was accepted.

Once the buy through transaction record has been created in the buy through system 150, the seller 202 purchases the desired product from a physical store or an online store. In various embodiments, the desired product is purchased at the location specified in the buy through listing. In a situation where the desired product cannot be purchased from the third party 203, the seller 202 contacts and notifies the buyer 201. One or more options may be presented to the buyer 201 to facilitate making a decision regarding the buy through transaction. The buyer 201 may decide to forfeit the transaction and choose another bidding seller from the list of sellers 202 who provided bids for the buy through listing. The buyer 201 may decide to wait and a new shipping and handling duration is agreed upon between the buyer 201 and the seller 202. The buyer 201 may decide to forfeit the transaction and cancel the buy through listing. The buyer 201 may decide to cancel the current buy through transaction and not enter into a new buy through transaction with another seller. Lastly, the seller 202 ships the desired product to the buyer 201 and the buyer 201 acknowledges receiving the desired product. The buyer 201 may submit a review of the seller 202 in some embodiments.

In another example embodiment, the buy through process flow for a seller 202 may start with a seller 202 subscribing to the buy through program to become an active seller 202. If a seller 202 is an active seller (also referred to as an existing seller), the seller 202 may receive notifications of pending buy through listings by email in some embodiments. In further embodiments, potential (not yet existing) sellers 202 may receive notifications through banners on the e-commerce site (and possibly other relevant sites as well). Interested potential sellers 202 may click through to a page (e.g., landing page shown by user interface 510 in FIG. 5A) which explains the process and what information they will need to fill out to become an active seller 202. The potential seller 202 fills in the relevant information including the seller's location and the radius they will be willing to receive relevant buy through listings, other relevant filters (categories they would like to sell in, price range they would like to see, etc.), and their preferred method of notification (by listing or as digest). In various embodiments, after submitting the information to activate them as subscribers, the active sellers 202 are notified by their preferred mode of notification of relevant buy through listings. In other embodiments, the active sellers 202 may search in a dedicated page on the e-commerce site for buy through listings based on location (not necessarily the location they have indicated when registering) or other parameters, and access buy through listings from the dedicated search page.

Certain embodiments are described herein as including logic or a number of components, modules, or mechanisms. Modules may constitute either software modules (e.g., code embodied on a machine-readable medium or in a transmission signal) or hardware modules. In various embodiments, the modules shown in FIGS. 1A-1B and FIGS. 2A-2B are specially configured as described in the specification. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

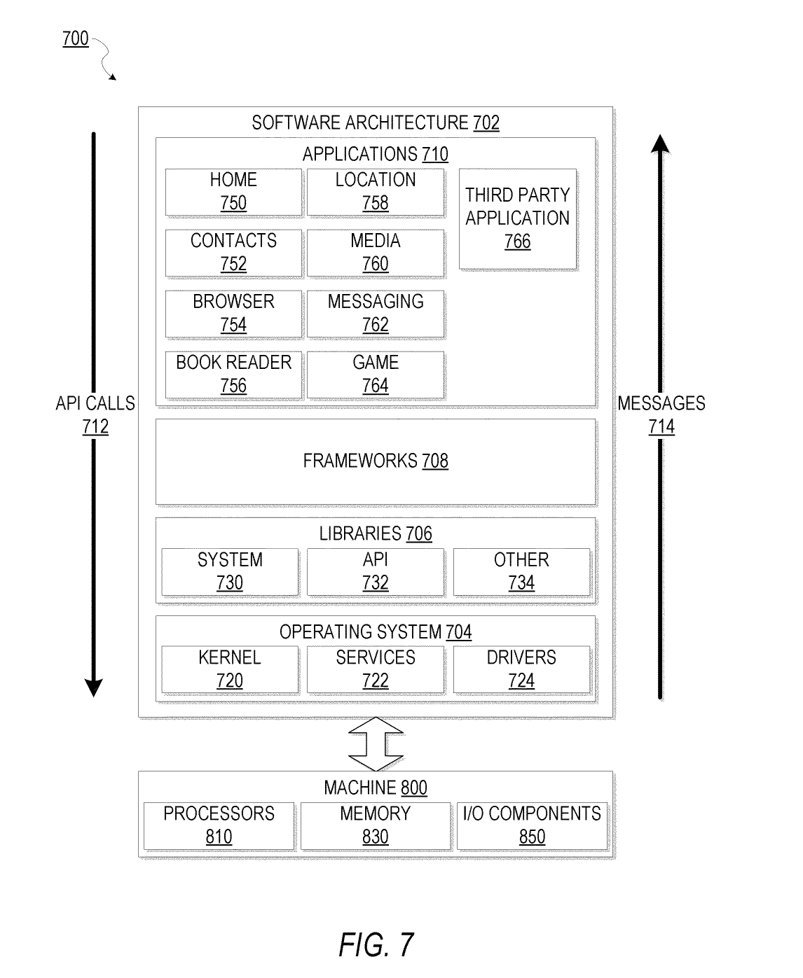

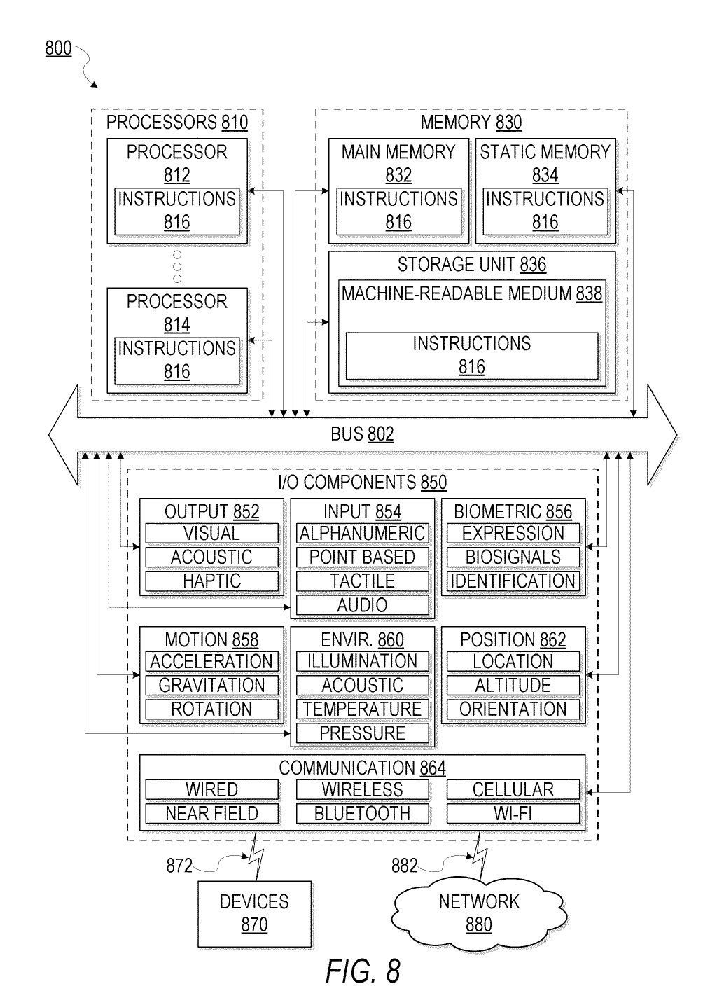

FIG. 7 is a block diagram 700 illustrating architecture of software 702, which may be installed on any one or more of devices described above. FIG. 7 is merely a non-limiting example of a software architecture and it will be appreciated that many other architectures may be implemented to facilitate the functionality described herein. The software 702 may be executing on hardware such as machine 800 of FIG. 8 that includes processors 810, memory 830, and input/output (I/O) components 850. In the example architecture of FIG. 7, the software 702 may be conceptualized as a stack of layers where each layer may provide particular functionality. For example, the software 702 may include layers such as an operating system 704, libraries 706, frameworks 708, and applications 710. Operationally, the applications 710 may invoke API calls 712 through the software stack and receive messages 714 in response to the API calls 712.

The operating system 704 may manage hardware resources and provide common services. The operating system 704 may include, for example, a kernel 720, services 722, and drivers 724. The kernel 720 may act as an abstraction layer between the hardware and the other software layers. For example, the kernel 720 may be responsible for memory management, processor management (e.g., scheduling), component management, networking, security settings, and so on. The services 722 may provide other common services for the other software layers. The drivers 724 may be responsible for controlling or interfacing with the underlying hardware. For instance, the drivers 724 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 706 may provide a low-level common infrastructure that may be utilized by the applications 710. The libraries 706 may include system 730 libraries (e.g., C standard library) that may provide functions such as memory allocation functions, string manipulation functions, mathematic functions, and the like. In addition, the libraries 706 may include API libraries 732 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 706 may also include a wide variety of other libraries 734 to provide many other APIs to the applications 710.

The frameworks 708 may provide a high-level common infrastructure that may be utilized by the applications 710. For example, the frameworks 708 may provide various graphic user interface (GUI) functions, high-level resource management, high-level location services, and so forth. The frameworks 708 may provide a broad spectrum of other APIs that may be utilized by the applications 710, some of which may be specific to a particular operating system or platform.

The applications 710 include a home application 750, a contacts application 752, a browser application 754, a book reader application 756, a location application 758, a media application 760, a messaging application 762, a game application 764, and a broad assortment of other applications such as third party application 766. In a specific example, the third party application 766 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 766 may invoke the API calls 712 provided by the mobile operating system 704 to facilitate functionality described herein.

FIG. 8 is a block diagram illustrating components of a machine 800, according to some example embodiments, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other via a bus 802. In an example embodiment, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 812 and processor 814 that may execute instructions 816. The term “processor” is intended to include multi-core processor that may comprise two or more independent processors (also referred to as “cores”) that may execute instructions contemporaneously. Although FIG. 8 shows multiple processors, the machine 800 may include a single processor with a single core, a single processor with multiple cores (e.g., a multi-core process), multiple processors with a single core, multiple processors with multiples cores, or any combination thereof.

The memory 830 may include a main memory 832, a static memory 834, and a storage unit 836 accessible to the processors 810 via the bus 802. The storage unit 836 may include a machine-readable medium 838 on which is stored the instructions 816 embodying any one or more of the methodologies or functions described herein. The instructions 816 may also reside, completely or at least partially, within the main memory 832, within the static memory 834, within at least one of the processors 810 (e.g., within the processor's cache memory), or any suitable combination thereof, during execution thereof by the machine 800. Accordingly, the main memory 832, static memory 834, and the processors 810 may be considered as machine-readable media 838.

As used herein, the term “memory” refers to a machine-readable medium 838 able to store data temporarily or permanently and may be taken to include, but not be limited to, random-access memory (RAM), read-only memory (ROM), buffer memory, flash memory, and cache memory. While the machine-readable medium 838 is shown in an example embodiment to be a single medium, the term “machine-readable medium” should be taken to include a single medium or multiple media (e.g., a centralized or distributed database, or associated caches and servers) able to store instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine 800 (e.g., processors 810), cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 850 may include a wide variety of components to receive input, provide output, produce output, transmit information, exchange information, capture measurements, and so on. It will be appreciated that the I/O components 850 may include many other components that are not shown in FIG. 8. The I/O components 850 are grouped according to functionality merely for simplifying the following discussion and the grouping is in no way limiting. In various example embodiments, the I/O components 850 may include output components 852 and input components 854. The output components 852 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 854 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and force of touches or touch gestures, or other tactile input components), audio input components (e.g., a microphone), and the like.

In further example embodiments, the I/O components 850 may include biometric components 856, motion components 858, environmental components 860, or position components 862, among a wide array of other components. For example, the biometric components 856 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 862 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via coupling 882 and coupling 872, respectively. For example, the communication components 864 may include a network interface component or other suitable device to interface with the network 880. In further examples, communication components 864 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as, location via Internet Protocol (IP) geo-location, location via Wi-Fi® signal triangulation, location via detecting a NFC beacon signal that may indicate a particular location, and so forth.

In various example embodiments, one or more portions of the network 880 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 880 or a portion of the network 880 may include a wireless or cellular network and the coupling 882 may be a Code Division Multiple Access (CDMA) connection, a Global System for Mobile communications (GSM) connection, or other type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 816 may be transmitted or received over the network 880 using a transmission medium via a network interface device (e.g., a network interface component included in the communication components 864) and utilizing any one of a number of well-known transfer protocols (e.g., HyperText Transfer Protocol (HTTP)). Similarly, the instructions 816 may be transmitted or received using a transmission medium via the coupling 872 (e.g., a peer-to-peer coupling) to devices 870. The term “transmission medium” shall be taken to include any intangible medium that is capable of storing, encoding, or carrying instructions 816 for execution by the machine 800, and includes digital or analog communications signals or other intangible medium to facilitate communication of such software.

Furthermore, the machine-readable medium 838 is non-transitory (in other words, not having any transitory signals) in that it does not embody a propagating signal. However, labeling the machine-readable medium 838 as “non-transitory” should not be construed to mean that the medium is incapable of movement; the medium should be considered as being transportable from one physical location to another. Additionally, since the machine-readable medium 838 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system, comprising:
at least one processor configured to perform operations for processor-implemented modules including:
a buyer listing module configured to:
receive buyer information specifying buyer product criteria to create buy through listings for selected products of buyers, the buyer product criteria including product information of the selected products, geographic location information of the selected products, a requested delivery date for the selected products, and pricing information for the selected products;
a seller activation module configured to:
receive seller information specifying seller purchase criteria related to a potential buy through transaction, the seller purchase criteria including geographic location information of sellers, product category information related to products the sellers are willing to acquire from third parties for the potential buy through transactions, and pricing information related to interested price ranges of products the sellers are interested in acquiring for the potential buy through transactions; and
a matching module configured to:
provide access to the buy through listings to the sellers who have seller purchase criteria matching the buyer product criteria.

2. The system of claim 1, further comprising:
a transaction module configured to:
receive at least one bid for one of the buy through listings;
after an expiration of an auction duration period for the one of the buy through listings, receive, from a buyer of the one of the buy through listings, an acceptance of one of the at least one bid; and
create a buy through transaction record.

3. The system of claim 1, further comprising:
a transaction module configured to:
receive a first seller commitment bid for one of the buy through listings; and
automatically create a buy through transaction record.

4. The system of claim 1, further comprising:
a transaction module configured to create a buy through transaction record associated with a buy through transaction between a buyer and a seller;
a dispute module configured to:
receive a seller dispute notification from the seller related to the buy through transaction, the seller dispute notification indicating the seller is unable to acquire the selected product in accordance with terms of the buy through transaction; and
send the seller dispute notification to the buyer of the buy through transaction, the seller dispute notification including at least one of the following options for the buyer to select from: accept a delayed delivery date, cancel the buy through transaction, or cancel the buy through transaction and enter into a new buy through transaction with a different seller.

5. The system of claim 1, wherein the buyer product criteria includes the product information representing a selected product not currently available for online purchase by the buyers based on current product listings on an e-commerce site, geographic location information representing a non-local region where the selected products are sold, and pricing information for the selected product.

6. A method comprising:
providing display information to present a buy through user interface to a buyer to create a buy through listing;
receiving buyer information specifying buyer product criteria to create the buy through listing, the buyer product criteria including product information, geographic location information, a requested delivery date, and pricing information, the product information representing a selected product not currently available for online purchase by the buyer based on current product listings on an e-commerce site, geographic location information representing a non-local region where the selected product is sold, and pricing information representing a desired buying price;
matching, using a processor of a machine, the buy through listing with seller purchase criteria from active sellers, the seller purchase criteria including geographic location information of the active sellers; and
providing access to the matching buy through listing to the active sellers.

7. The method of claim 6, further comprising:
receiving at least one seller bid for the buy through listing;
receiving a buyer's acceptance for one of the seller bids; and
creating a buy through transaction record.

8. The method of claim 6, wherein providing access to the buy through listing to the active sellers further comprises:
providing notification to the active sellers matching the buy through listing.

9. The method of claim 6, wherein providing access to the buy through listing to active sellers further comprises:
receiving search criteria for buy through listings from one of the active sellers;
searching based on the geographic location of the selected product and the active sellers; and
providing search results for the buy through listing if the search criteria matches the buyer product criteria specified in the buy through listing.

10. The method of claim 6, wherein the seller purchase criteria includes seller location information representing an address where the seller is located and a radius from the address within which the seller is willing to acquire products from a third party for the buy through listing.

11. The method of claim 7,
wherein receiving at least one seller bid for the buy through listing further comprises receiving a first seller commitment bid; and
wherein creating the buy through transaction record further comprises automatically creating the buy through transaction record when the first seller bid is received.

12. The method of claim 7,
wherein receiving at least one seller bid for the buy through listing further comprises receiving multiple seller bids for the buy through listing; and
wherein receiving a buyer's acceptance for one of the seller bids further comprises receiving the buyer's acceptance of one of seller bids after an expiration of the auction duration period for the buy through listing.

13. The method of claim 6, wherein pricing information representing a desired buying price includes a breakdown of pricing by at least: product cost, service cost, and shipping cost.

14. The method of claim 7, further comprising:
receiving a seller dispute notification, the seller dispute notification indicating that the seller is unable to acquire the selected product in accordance with terms of a buy through transaction related to the buy through transaction record; and
sending the seller dispute notification to the buyer of the buy through transaction, the seller dispute notification including at least one of the following options for the buyer to select from: accept a delayed delivery date, cancel the buy through transaction, or cancel the buy through transaction and enter into a new buy through transaction with a different seller.

15. A non-transitory machine readable medium storing instructions that, when executed by at least one processor of a machine, cause the machine to perform operations comprising:
providing display information to present a buy through user interface to a seller to activate the seller as a buy through seller;
receiving seller information specifying seller purchase criteria related to a potential buy through transaction, the seller purchase criteria including a geographic location information of the seller, product category information related to products the seller is willing to acquire, and pricing information related to interested price ranges of the products the seller is willing to acquire; and
activating the seller as the buy through seller, wherein the active seller is provided access to buy through listings matching the seller purchase criteria, the buy through listings specifying selected products not currently available for purchase on an e-commerce site.

16. The non-transitory machine readable medium of claim 15, wherein the operations of receiving seller information further comprise:
receiving the seller purchase criteria including the seller location information representing an address where the seller is located and a radius from the address within which the seller is willing to acquire the selected products from a third party for the buy through listings.

17. The non-transitory machine readable medium of claim 15, wherein the operations further comprise:
receiving a first seller commitment bid; and
automatically creating a buy through transaction record upon receipt of the first seller commitment bid.

18. The non-transitory machine readable medium of claim 15, wherein the operations further comprise:
receiving an auction bid from the seller;
receiving an acceptance from the buyer of the auction bid; and
creating a buy through transaction record.

19. The non-transitory machine readable medium of claim 15, wherein the operations further comprise:
receiving a seller dispute notification, the seller dispute notification indicating that the seller is unable to acquire the selected product in accordance with terms in a buy through transaction associated with the buy through transaction record; and
sending the seller dispute notification to the buyer of the buy through transaction, the seller dispute notification including at least one of the following options for the buyer to select from: accept a delayed delivery date, cancel the buy through transaction, cancel the buy through transaction and enter into a second buy through transaction with a second seller.

20. The non-transitory machine readable medium of claim 18, wherein the operation of receiving the auction bid from the seller further comprises:
receiving pricing information for the selected product including a breakdown of pricing by at least: product cost, service cost, and shipping cost.
